(19) United States
(12) Patent Application Publication
(10) Pub. No.: US 2024/0329439 A1
(43) Pub. Date: Oct. 3, 2024

(54) INTEGRATED MAGNETO-OPTICAL MODULATOR

(71) Applicant: The Regents of the University of California, Oakland, CA (US)

(72) Inventors: Paolo PINTUS, Goleta, CA (US); John E. BOWERS, Santa Barbara, CA (US)

(73) Assignee: The Regents of the University of California, Oakland, CA (US)

(21) Appl. No.: 18/579,443

(22) PCT Filed: Jul. 22, 2022
(86) PCT No.: PCT/US2022/038008

§ 371 Date: Jan. 15, 2024

Related U.S. Application Data
(60) Provisional application No. 63/224,487, filed on Jul. 22, 2021.

(51) Int. Cl. G02F 1/095; G02F 1/00

(52) U.S. Cl. CPC G02F 1/0955; G02F 1/0036

(57) ABSTRACT

An optical modulator and method of fabricating an optical modulator. The optical modulator includes a first optical waveguide with an input port configured to receive an unmodulated optical signal and an output port; an magneto-optical layer located adjacent to the first optical waveguide, wherein optical attributes of the magneto-optical layer vary in relation to a magnetic field: and a conductive layer located in close proximity to a portion of the magneto-optical layer located adjacent to the first optical waveguide, wherein current injected to the conductive layer generates a magnetic field oriented perpendicular to a direction of propagation of light within the first optical waveguide.

### STATEMENT OF GOVERNMENT INTEREST

This invention was made with government support under contract FA8650-16-C-1758 awarded by the U.S. Air Force Research Laboratory and under contract FA9550-21-1-0042 awarded by the Air Force Office of Scientific Research. The government has certain rights in the invention.

### TECHNICAL FIELD

The invention relates generally to integrated optical modulators and in particular to integrated optical modulators utilized nonreciprocal phase shift.

### BACKGROUND

Modulation is the action of varying (modulating) the frequency, the phase or the amplitude of a wave (carrier) in order to transfer information. This operation is the key of any communication system. In an optical communication system, the carrier is an optical wave and the modulation is usually performed based on the electro-optic effect. This effect is based on inducing variations in the optical properties of a material (i.e., refractive index or optical loss) in response to the application of an external electric field. Electro-optic modulators have been demonstrated to modulate the phase or the amplitude of the light by using a radio frequency modulating electrical signal.

The integration of optical modulators allows reduction of size, cost, and power consumption. Silicon photonics platform can be used to meet those requirements. Several integrated electro-optic solutions have been proposed based on different electro-optic materials such as lithium niobate, III-V semiconductors, organic materials, and purely silicon.

Each of these solutions present different limitations, such as the challenging integration of the material on silicon photonics platform (e.g., lithium niobate); the large absorption in the materials at radio frequency (III-V semiconductors) which limits the maximum modulation frequency; the material degradation over time (organic materials); and the intrinsically limited modulation bandwidth (purely silicon).

It would therefore be beneficial to develop optical modulators capable of overcoming these limitations.

### BRIEF DESCRIPTION OF THE DRAWINGS

FIG. 1A is an isometric view of an integrated optical modulator for a transverse magnetic (TM) optical mode according to some embodiments; FIG. 1B is a cross-sectional view of the integrated optical modulator shown in FIG. 1A according to some embodiments; FIG. 1C is a top view of the integrated optical modulator according to some embodiments; and FIG. 1D is a magnified top view of the integrated optical modulator according to some embodiments.

FIG. 2A illustrates polarization rotation according to some embodiments; FIG. 2B-illustrates a configuration that provides nonreciprocal phase shift for transverse electric (TE) polarization according to some embodiments; FIG. 2C illustrates a configuration that provides a nonreciprocal phase shift for TM polarization according to some embodiments; and FIG. 2D is a cross-sectional view illustrating interaction of the electromagnet and waveguide for a TE optical mode according to some embodiments.

FIG. 3 is a top view of an integrated modulator based on a Mach-Zehnder interferometer according to some embodiments.

FIG. 4 is a cross-sectional view of the integrated modulator shown in FIG. 3 according to some embodiments.

FIG. 5 is cross-sectional view illustrating fabrication of a TM optical modulator according to some embodiments.

### DETAILED DESCRIPTION

According to some aspects, an optical modulator is provided that operates on the principle of nonreciprocal phase shift in magneto-optic materials. An optical signal traveling in a magneto-optic material is modified in non-reciprocal fashion in response to application of a magnetic field due to the magnetic field modifying optical attributes of the magneto-optic material. Non-reciprocal effects include rotation of the polarization plane, perturbation of the phase velocity, or variation of the propagation loss according to the direction of propagation and orientation of the magnetic field. According to one aspect, the optical modulator is implemented by a magneto-optic ring, wherein the magnetic field is provided in a direction perpendicular to the propagation of light within the optical ring or microring. By selectively modifying one or more of the direction, orientation and/or amplitude of the magnetic field, a corresponding change in resonance of the optical ring resonator is provided that can be used to modulate the optical signal. According to another aspect, the optical modulator is implemented as a travelling wave magneto-optic modulator that includes two parallel microstrips positioned adjacent respective waveguides. Radio frequency (RF) signals applied between the parallel microstrips. The RF signal creates a difference of potential at RF frequencies propagates between the two parallel microstrips, inducing currents with opposite directions. This results in a push-pull configuration where the phase shifts in the two arms have opposite signs. The RF signal is utilized to rapidly modulate the phase shift in the two arms, thereby modulating the optical signal injected at one of the respective ports. The proposed invention can be efficiently integrated on silicon waveguide (e.g., bonding) and, more generally, on any kind of integrated optical waveguide. In addition, magneto-optic materials do not suffer from plasma free carrier absorption, like in semiconductor at RF frequency, and performs reliably over time.

The proposed invention may operate at temperatures of 4 Kelvin (K) (or lower) and may operate as a highspeed magneto-optic modulator. For example, the modulator may have a data rate of Gigabits per second (Gbps) with an energy consumption femto Joules (fJ) per bit of transferred information. The proposed invention can enable data links in large-scale systems for cryogenic supercomputing and quantum information processing.

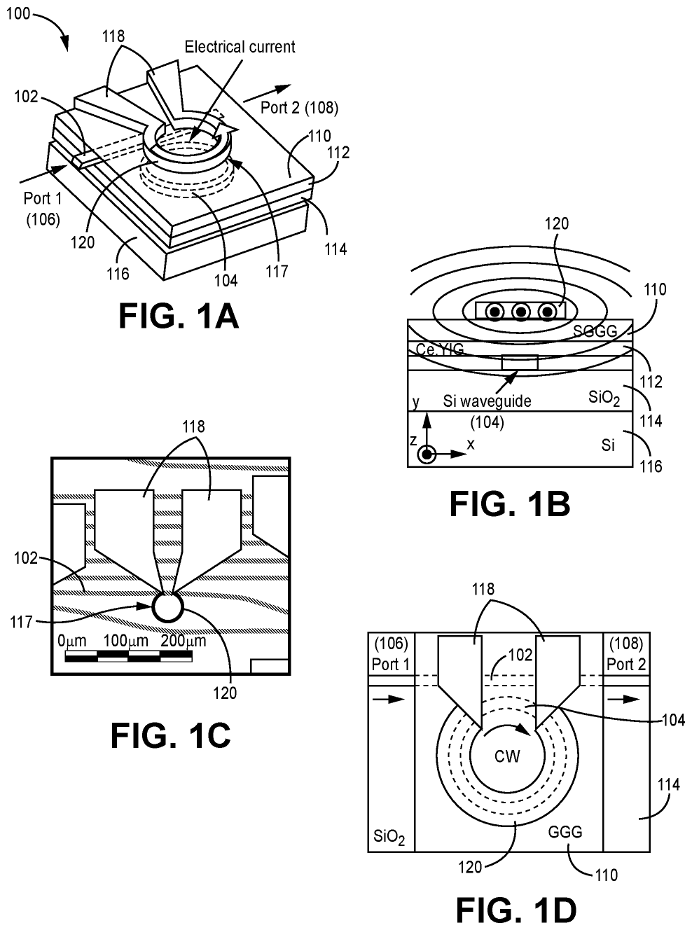

FIG. 1A is an isometric view of an integrated optical modulator 100 utilizing a magneto-optic ring according to some embodiments. FIG. 1B is a cross-sectional view that illustrates the various layers of the integrated optical modulator 100 in relation to one another. FIG. 1C is a top view of the integrated optical modulator 100 fabricated on a photonic integrated circuit (PIC). FIG. 1D is a magnified top view of the integrated optical modulator 100.

In the embodiment shown in FIG. 1A, the integrated optical modulator 100 includes a waveguide (e.g., silicon waveguide) 102 having a first port (i.e., input port) 106 and a second port (i.e., output port) 108. The integrated optical modulator 100 includes a magneto-optic substrate (e.g., gadolinium gallium garnet (GGG) or substituted gadolinium gallium garnet (SGGG)) 110, top-cladding magneto-optic material (e.g., Ce: YIG, Te: EuSe, Te: EuS, Cd₁₋ₓMnₓTe) 112, an insulative cladding layer 114 (e.g., silicon-dioxide (SiO₂), silicon nitride (Si₃N₄)) and a silicon substrate 116. In some embodiments, the silicon waveguide 102 is optically coupled to a microring 104, which is a waveguide having a circular geometry. The diameter of the microring 104 may be sized to minimize bending loss. In one non-limiting example, the microring 104 has a diameter of 70 μm. The propagation of the light wave through the waveguide 104 is affected by the optical properties of the magneto-optic material 112 located adjacent to the waveguide 104. In turn, as a magneto-optic material, the optical properties of the magneto-optic material 112 can be modified by application of a magnetic field to the magneto-optic material 112. In some implementations, the magneto-optic material 112 is optically transparent to wavelengths of about 1550 nm.

In the embodiment shown in FIGS. 1A-1C, an integrated electromagnet 117 comprised of conductive tabs 118 and a conductive ring 120 connected to the conductive tabs 118 is positioned adjacent to the microring 104. The conductive tabs 118 and/or the conductive ring 120 may comprise gold or a superconductor material. The electromagnet 117 is configured to generate a magnetic field in response to current flowing through the conductive tabs 118 and the conductive ring 120. The intensity and direction of the magnetic field is determined based on the intensity and direction of current through the conductive ring 120 and can be selectively controlled to provide the desired modulation to the optical signal. In other words, controlling the direction and amplitude of the current in the electromagnet 117 can modulate the effective index of the optical mode underneath, and therefore the resonance of the microring resonator 104.

As a result, optical signal provided between the first port 106 and the second port 108 can be modulated by modulating the flow of current provided to the electromagnet 117.

According to some aspects, an unmodulated optical signal is provided as an input to the waveguide 102 via input port 106. The unmodulated optical signal is coupled to microring 104, which modulates the optical signal via selective modulation of the current provided to the integrated electromagnet 117. A modulated optical signal is provided as an output at the output port 108. Selectively switching the direction of current in the integrated electromagnet 117 provides a change in resonance of optical microring 104. The change in resonance of the microring 104 results in optical modulation of the optical signal propagating between the first port 106 and the second port 108 and coupled to the microring 104. In some embodiments, the integrated optical modulator provides phase modulation of the optical signal. In other embodiments, through constructive/destructive interference, the integrated optical modulator provides amplitude modulation of the optical signal.

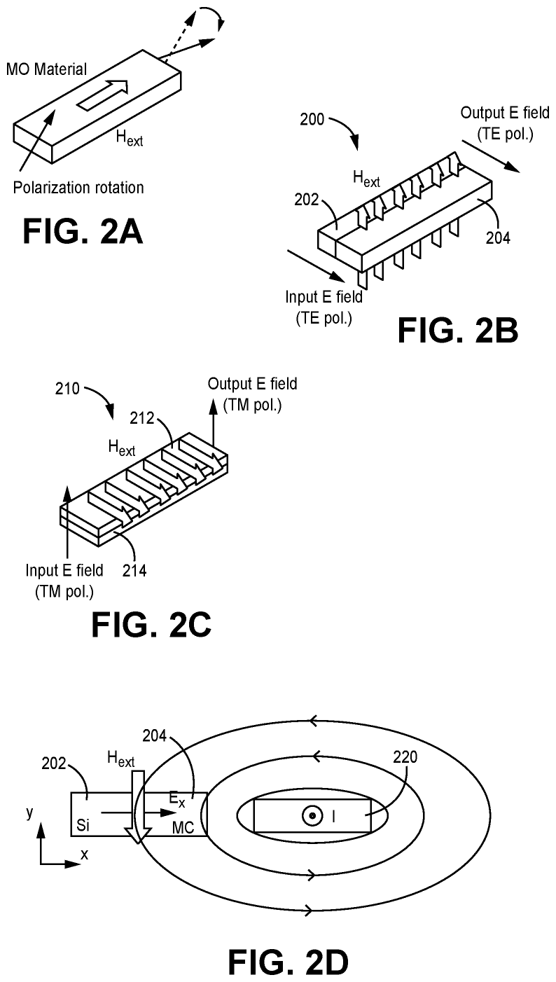

The cross-sectional view shown in FIG. 1B is taken along the microring structure 104 shown in FIG. 1A. The cross-sectional view illustrates the respective layers utilized to form the integrated optical modulator 100. In the embodiment shown in FIG. 1B, a silicon waveguide 104 is formed on an insulating layer (e.g., SiO₂, Si₃N₄) 114. A magneto-optic material (e.g., Ce: YIG, Tc: EuSe, Te:EuS, Cd₁₋ₓMnₓTe) 112, covered by a magneto optic substrate (e.g., GGG, SGGG) 110, is bonded or otherwise affixed to the silicon waveguide 104. The integrated electromagnet 117 is formed on top of the magneto optic substrate 110. In the embodiment shown in FIG. 1B, light travels through the waveguide in one direction (e.g., into the page). Current through the integrated electromagnet 117 may be selectively controlled to change direction—either into the page or out of the page. In the embodiment shown in FIG. 1B current is flowing out of the page, and the corresponding magnetic field is counterclockwise (via the right-hand rule). If the direction of the current is changed to flowing into the page, the direction of the magnetic field would be modified to clockwise. In both cases, the magnetic field is oriented perpendicular to the direction of travel of the light within the silicon waveguide 104. When the applied magnetic field is perpendicular to the direction of propagation of the optical signal (Voigt configuration), the forward and backward propagating waves exhibit different phase velocities, resulting in a non-reciprocal phase shift (NRPS) effect. In contrast. if the magnetic field were oriented parallel to the direction of propagation of the optical signal (Faraday configuration as illustrated in FIG. 2A), the magnetic field would cause polarization rotation of the optical field rather than phase variation. The latter type of configuration allows for modulation of the optical signal, it requires optical polarization filters in order to decode the modulated signal. Polarization filters are difficult to fabricate and therefore desirable to provide an integrated optical modulator that does not required optical polarization filters, as such in the proposed configuration

In order to maximize the non-reciprocal phase shifting (NRPS) effect, the cross-section of the optical waveguide 104 within the microring 104 is designed based on the waveguide mode. For example, for the transverse electric (TE) mode, the optimum waveguide cross-section is horizontally discontinuous and the external magnetic field is perpendicular to the plane of the circuit as shown in FIG. 2B. Likewise, for the transverse magnetic (TM) mode, the waveguide is vertically discontinuous, and the magnetic field is in the plane of the waveguide as shown in FIG. 2C. The embodiment shown in FIGS. 1A-1C is applicable to TM mode modulation, although a TE mode waveguide could be constructed with modification to the waveguide cross-section and position of the electromagnet. For example, the embodiment shown in FIG. 2D illustrates positioning of the waveguide relative to the conductor to operate in TE mode. In the embodiment shown in FIG. 2D, the waveguide includes silicon waveguide 202 located adjacent to the magneto-optic material 204 with a horizontal discontinuity and the external magnetic field created by the current flowing through conductor 220 is perpendicular to the plane of the circuit.

In addition, another benefit of the integrated optical modulator 100 shown in FIGS. 1A-1C is that the modulation is provided by injected current and not be an applied voltage as is common in typical electro-optic modulators. Current-driven modulators are ideal for low-impedance circuits, such as Rapid Single Flux Quantum (RSFQ) logic and superconducting circuits. Further, the materials utilized in the integrated optical modulator 100 have a dielectric behavior, which minimizes RF propagation loss as compared with typical electro-optic modulators. In addition. isolation is provided by the non-reciprocal property of the magneto-optic material and therefore does not require separate optical isolators to implement.

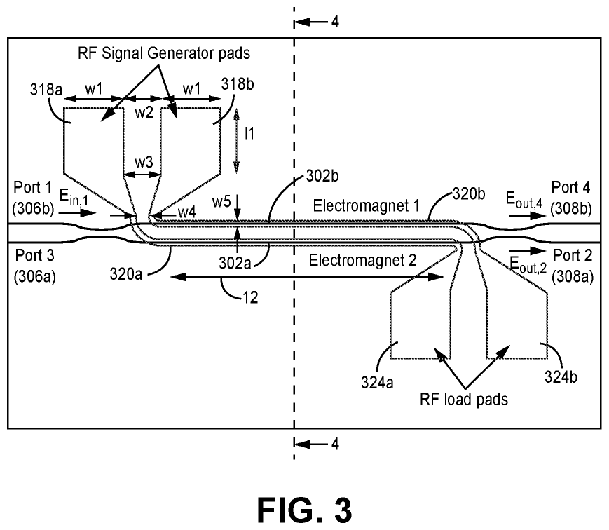

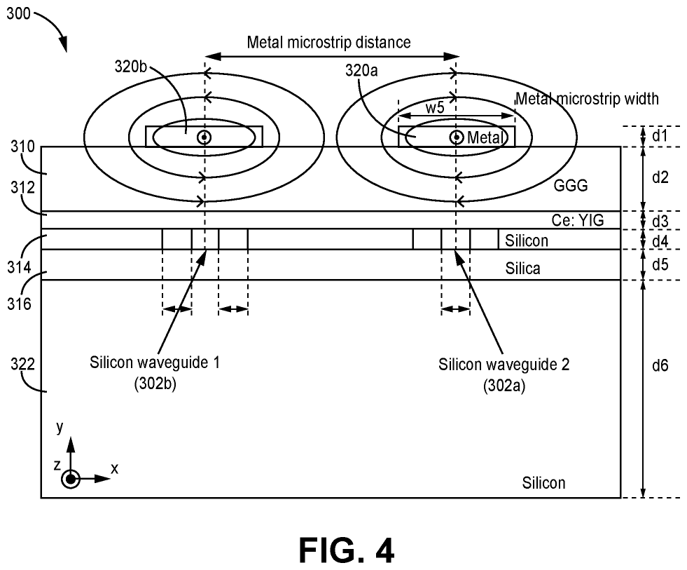

Referring now to FIGS. 3 and 4, an integrated optical modulator 300 is provided that utilizes a Mach-Zehnder travelling wave magneto-optic modulator. FIG. 3 is a top view of the travelling wave magneto-optic modulator 300, and FIG. 4 is a cross-sectional view of the modulator 300.

In some embodiments, the travelling wave magneto-optic modulator 300 includes first and second optical waveguides 302a, 302b, first and second RF signal generator pads 318a, 318b, microstrips 320a, 320b, and RF load pads 324a, 324b. First optical waveguide 302a includes an input port 306a and an output port 308a. Likewise, second optical waveguide 302b includes an input port 306b and an output port 308b. In some embodiments, the RF signal generator pads 318a, 318b are defined by a width w1 and a length II. Likewise, the RF signal generator pads 318a, 318b are separated from one another by widths w2, w3, and w4 at respective locations shown in FIG. 3. The width of the microstrips 320a, 320b is given by w5, and the length of the microstrips 320a, 320b is given by 12. The RF signal generator pad 318a is coupled to the RF load pad 324a via microstrip 320a. Likewise, RF signal generator pad 318b is coupled to the RF load pad 324b via microstrip 320b. The RF signal generator pads 318a, 318b, microstrips 320a, 320b, and RF load pads 324a, 324b are conductive (e.g., gold, another metal or a superconductor material) and act as coupled (coplanar) microwave-waveguide. The impedances of the RF generator pads 318a, 318b, of the two coplanar microwave-waveguide (microstrips 320a, 320b) and the RF load pads 324a, 324b are matched (e.g., 5052). The reason of this electrical configuration is the following: when an RF signal is applied between the two microstrips 320a, 320b via the RF signal pads 318a, 318b, a difference of potential at RF frequency propagates between the two parallel metal inducing currents with opposite directions. Such current is used to control the magneto-optic effect associated with the optical waveguides 302a, 302b. The result is a Mach-Zehnder interferometer in push-pull configuration where the phase shifts in the two arms (e.g., first and second optical waveguide 302a, 302b) have opposite sign. The RF signal is used to rapidly modulate the phase shift in the two arms of the Mach-Zehnder interferometer, modulating the optical signal injected from first port 306a, or second port 306b.

FIG. 4 is a cross-sectional view taken along line 4-4 shown in FIG. 3. As shown, the traveling wave magneto-optic modulator 300 includes magneto-optic substrate (GGG, SGGG) 310, top-cladding magneto-optic material (e.g., Ce: YIG, Te: EuSe, Te: EuS, Cd₁₋ₓMnₓTe) 312, silicon waveguide layer 314, which includes first and second optical waveguides 302a, 302b, silica layer 316, and silicon substrate 322. First and second microstrips 320a, 320b are positioned directly above the respective first and second optical waveguides 302a, 302b. In some embodiments, first and second microstrips 320a, 320b are defined by a depth d1, magneto-optic substrate 310 is defined by depth d2, magneto-optic material 312 is defined by depth d3, silicon waveguide layer 314 is defined by depth d4, silica layer 316 is defined by depth d5, and silicon substrate 322 is defined by depth d6.

As discussed above with respect to FIGS. 1A-1C, benefits of the integrated optical modulator 300 includes modulation provided via injected current and not via an applied voltage as is common in typical electro-optic modulators. Further, the materials utilized in the integrated optical modulator 300 have a dielectric behavior, which minimizes RF propagation loss as compared with typical electro-optic modulators. In addition, isolation is provided by the non-reciprocal property of the magneto-optic material and therefore does not require separate optical isolators to implement. The embodiment shown in FIGS. 3 and 4 is applicable to TM mode modulation, although a TE mode waveguide could be constructed with modification to the waveguide cross-section and position of the electromagnet (coplanar microwave-waveguide).

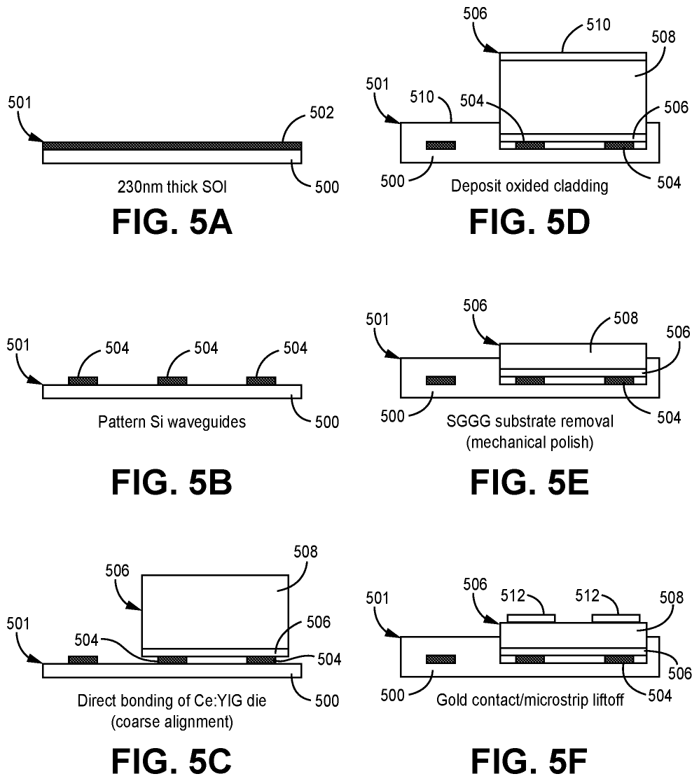

Referring to FIG. 5, a method of fabricating the integrated optical modulator according to some embodiments. In some embodiments, the manufacturing process relies on bonding the magneto-optic material onto a silicon photonic die platform (e.g., die or substrate 501). In particular, a magneto-optic die 506 is bonded on a pre-patterned silicon waveguide die 501 and a metal microstrip is fabricated close to the heterogeneous stack (i.e., waveguide and magneto-optic cladding) in order to act as electromagnet and apply the required magnetic field. Alternatively, the magneto-optic material can be deposited using pulsed laser deposition or sputtering.

In the embodiment shown in FIG. 5, at step (a) a silicon layer 502 is deposited onto an insulating layer 500. In some embodiments, the insulating layer is a silicon dioxide (SiO₂) layer fabricated on a silicon substrate (e.g., silicon-on-insulator (SOI)). In some embodiments, the silicon layer 502 has a thickness (e.g., 230 nm) less than that of the insulating layer 500.

At step (b), silicon waveguides 504 are patterned from the silicon layer 502. In some embodiments, an etching processing is utilized to pattern the waveguides. In one non-limiting example, the silicon waveguide 504 has a width of 600 nm wide and a height of 220 nm.

At step (c), a magneto-optic die 506 is bonded to the patterned silicon waveguides 504. In some embodiments, the magneto-optic die 506 includes a magneto-optic substrate (GGG, SGGG) 508 and magneto-optic material (e.g., Ce: YIG, Te: EuSe, Te: EuS, Cd₁₋ₓMnₓTe) 506, wherein the magneto-optic material 506 is positioned adjacent to the patterned silicon waveguide 504. In some embodiments, only coarse alignment of the magneto-optic die 506 and the silicon waveguide die is required, with subsequent processing steps utilized to fabricate the electromagnets utilized to modify the optical attributes of the magneto-optic material. In some implementations, the magneto-optic material 506 has a thickness of 400 nm and/or the material 508 has a thickness of 5 μm.

At step (d), a protective oxide cladding layer 510 is deposited. At step (e), a mechanical polish step is utilized to remove a portion of the magneto-optic substrate material 506. Alternatively, a selective etching process may be utilized instead of, or in addition to, mechanical polishing. Utilizing a selective etching process may decrease the distance between the electromagnet and the interface of the Si layer 502/magneto-optic material 506 compared to mechanical polishing. A decreased distance may result in a reduction of the required current amplitude for modulation. At step (f), the electromagnet (e.g., microstrips 512) are deposited in alignment with the silicon waveguides 502. The electromagnetic may be a conductive material (e.g., gold, or a superconductor). In some implementations, the electromagnet is a circular electrode with a cross section of 3 μm×1.5 μm.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An optical modulator comprising:
a first optical waveguide including an input port configured to receive an unmodulated optical signal and an output port;
a magneto-optical layer located adjacent to the first optical waveguide, wherein optical attributes of the magneto-optical layer vary in relation to a magnetic field; and
a conductive layer located in close proximity to a portion of the magneto-optical layer located adjacent to the first optical waveguide, wherein current injected to the conductive layer generates a magnetic field oriented perpendicular to a direction of propagation of light within the first optical waveguide.

2. The optical modulator of claim 1, further comprising a microring optically coupled to the first optical waveguide, the microring configured to modulate the unmodulated optical signal.

3. The optical modulator of claim 2, wherein a cross-section of the microring is vertically discontinuous.

4. The optical modulator of any one of claim 2, wherein the conductive layer comprises conductive tabs and a conductive ring, wherein the conductive ring is positioned adjacent to the microring.

5. The optical modulator of claim 1, wherein the conductive layer is configured as a coupled microwave-waveguide to modulate the unmodulated optical signal.

6. The optical modulator of claim 5, further comprising a second optical waveguide including an input port configured to receive an unmodulated optical signal and an output port.

7. The optical modulator of claim 6, wherein the microwave-waveguide comprises:
a first RF signal generator pad coupled to a first RF load pad via a first microstrip; and
a second RF signal generator pad coupled to a second RF load pad via a second, wherein the second RF signal generator pad is separated from the first RF signal generator pad, the second RF load pad is separated from the first RF load pad, and the second microstrip is separated from and parallel to the first microstrip.

8. The optical modulator of claim 7, wherein the first microstrip is positioned above the first optical waveguide and the second microstrip is positioned above the second optical waveguide.

9. The optical modulator of claim 1, wherein the magneto-optical layer comprises a first magneto-optic material and a second magneto optic material different from the first magneto-optic material.

10. The optical modulator of claim 9, wherein the first magneto-optic material is gadolinium gallium garnet (GGG) and the second magneto optic material is cerium substituted yttrium iron garnet (Ce: YIG).

11. The optical modulator of claim 1, wherein the first optical waveguide is positioned on an insulating layer.

12. The optical modulator of claim 11, wherein the insulating layer is positioned on a silicon substrate.

13. The optical modulator of claim 1, wherein the output port is configured to output a modulated optical signal.

14. The optical modulator of claim 1, wherein the optical modulator operates in a transverse electric (TE) mode.

15. A method of manufacturing the optical modulator of claim 1 comprising:
depositing a silicon layer onto an insulating layer;
pattering a waveguide in the silicon layer;
bonding a magneto-optic material to the waveguide;
depositing an oxide cladding layer;
removing a portion of the magneto optic material; and
depositing a conductive layer in alignment with the waveguide.

16. The method of claim 15 wherein the magneto-optic material includes a magneto-optic substrate and a layer of magneto-optic material, wherein the magneto-optic material is different from the magneto-optic substrate.

17. The method of claim 16, wherein the magneto optic substrate is gadolinium gallium garnet (GGG) and the magneto-optic material is cerium substituted yttrium iron garnet (Ce: YIG).

18. A method of manufacturing an optical modulator comprising:
depositing a silicon layer onto an insulating layer;
pattering a waveguide in the silicon layer;
bonding a magneto-optic material to the waveguide;
depositing an oxide cladding layer;
removing a portion of the magneto optic material; and
depositing a conductive layer in alignment with the waveguide (504).

19. The method of claim 18 wherein the magneto-optic material includes a magneto-optic substrate and a layer of magneto-optic material, wherein the magneto-optic material is different from the magneto-optic substrate.

20. The method of claim 19, wherein the magneto optic substrate is gadolinium gallium garnet (GGG) and the magneto-optic material is cerium substituted yttrium iron garnet (Ce: YIG).
